(19) United States
(12) Patent Application Publication
(10) Pub. No.: US 2006/0277316 A1
(43) Pub. Date: Dec. 7, 2006

(54) Internet protocol television

(76) Inventors: Yunchuan Wang, Beijing (CN); Wei Shu, Beijing (CN); Michael Her, St. James, NY (US)

Correspondence Address: F. CHAU & ASSOCIATES, LLC, 130 WOODBURY ROAD, WOODBURY, NY, 11797, US

(21) Appl. No.: 11/433,142

(22) Filed: May 12, 2006

Related U.S. Application Data
(60) Provisional application No. 60/680,331, filed on May 12, 2005.
(60) Provisional application No. 60/680,332, filed on May 12, 2005.
(60) Provisional application No. 60/751,579, filed on Dec. 19, 2005.

(51) Int. Cl. G06F 15/16

(52) U.S. Cl. 709/231

(57) ABSTRACT

An on-demand video delivery system, comprising: a program center having a content server for receiving and storing media signals representing humanly perceptible video programs and for converting the media signals into coded media data suitable for streaming over the Internet; and a plurality of delivery servers, each connected to the content server and the Internet for establishing an unicast link over the Internet with a respective one of a plurality of set top boxes (STBs) to deliver, upon request made from an STB for a video program, the requested video program by streaming over the Internet using Internet Protocol (IP), wherein each of the STBs includes: a buffer for receiving and temporarily storing a requested video program streamed from a delivery server over the Internet; a decoder for converting the coded media data to humanly perceptible video, and a processor for coordinating presentation of the humanly perceptible video to play on a television while the buffer receives packets of downstream coded media data from the respective delivery server.

This application claims priority to provisional applications Ser. Nos. 60/680,331, and 60/680,332, both filed on May 12, 2005, and provisional application No. 60/751,579 filed on Dec. 19, 2005. The disclosures of the provisional applications are incorporated by reference in their entirety herein.

### BACKGROUND

1. Technical Field

The present disclosure describes a system for delivering live television broadcasts or video on demand programs to subscribers using the internet protocol (IPTV). The mode of delivery can be by streaming and/or download over the Internet.

2. Discussion of Related Art

Video-on-demand or television program on demand have been made available to and utilized by satellite/cable television subscribers. Typically, subscribers can view at their television the video programs available for selection for a fee, and upon selection made at the subscriber's set-top-box (STB), the program is sent from the program center to the set-top-box via the cable or satellite network. The large bandwidth available at a cable or satellite network, typically at a capacity of 400 Mbps to 750 Mbps or higher, facilitates download of a large portion or the entire selected video program with very little delay. Some set-top-boxes are equipped with storage for storing the downloaded video and the subscriber watches the video program from the STB as if from a video cassette/disk player.

More recently, a selection of television programs are made available for viewing over the Internet using a browser and a media player at a personal computer. In some cases, the requested programs are streamed instead of downloaded to the personal computer for viewing. In these systems, the video programs are not viewed at a television through an STB. Nor is the viewing experience the same as watching from a video disk player because the PC does not respond to a remote control as does a television or a television STB. Even though media players on PCs can be controlled by a virtual on-screen controller, the control and viewing experience through a mouse or keyboard is different from a disk player and a remote control. Further, most PC users use their PCs on a desk in an actual or home office arrangement, which is not conducive to watching television programs or movies, e.g., the furniture may not be comfortable and the audiovisual effects cannot be as well appreciated. Moreover, if a PC accesses the Internet via a LAN and the access point is via DSL, the bandwidth capacity may be only 500 Kbps to 2 Mbps. This bandwidth limitation may render difficult a real-time, uninterrupted program streamed over the Internet unless the viewing area is made very small or very low resolution, or unless a highly compressed and speed optimized codec is used.

With the use of the Internet as the medium for streaming, because the nature of Internet Protocol is a “best effort” service, there is no guarantee on Quality of Service (“QoS”). The IPTV service provider has little control on the rate and quality of the signals received at the PC or set-top box because there is little control on QoS of the IP link between the provider and the subscriber, especially if existing commercially available streaming servers are used. Thus, the subscriber experience in program selection and delivery varies with the variations in QoS of the IP link.

A need therefore exists for a robust streaming solution that makes the IPTV a reality irrespective of the network QoS requirements.

### SUMMARY OF THE INVENTION

An on-demand video delivery system is provided, comprising: a program center having a content server for receiving and storing media signals representing humanly perceptible video programs and for converting the media signals into coded media data suitable for streaming over the Internet; and a plurality of delivery servers, each connected to the content server and the Internet for establishing an unicast link over the Internet with a respective one of a plurality of set top boxes (STBs) to deliver, upon request made from an STB for a video program, the requested video program by streaming over the Internet using Internet Protocol (IP), wherein each of the STBs includes: a buffer for receiving and temporarily storing a requested video program streamed from a delivery server over the Internet; a decoder for converting the coded media data to humanly perceptible video, and a processor for coordinating presentation of the humanly perceptible video to play on a television while the buffer receives packets of downstream coded media data from the respective delivery server.

Preferably, the coded media data is in a compressed form, which can be MPEG4 or MPEG4 compliant, and the packets of coded media data is in H.264 Streaming Format, wherein each of the delivery servers includes a streaming controller employing one of a RTSP, Real System, or MPEG4 streaming protocol to stream the coded media data to a STB. The presentation of the humanly perceptible video to play on a television is in one of interlaced, NTSC, or PAL format.

According to an aspect of the invention, each of the STBs is configured to connect to the Internet with a browser and each STB has its browser preset to the subscriber welcome home page, and each STB is configured to receive and process video program viewing control commands including play, stop, pause, and forward and backward, wherein upon receipt of a STOP command at an STB, information about the title and frame of the stopped video program is stored in a database at the program delivery center, and the information is retrieved upon the next selection of the same video program from the same STB to play back the video program from the point of stoppage. Each STB includes a network interface for connecting to a wireless access point (WAP). According to another aspect of the invention, at least one of the STBs further includes a DVR for storing video programs received from the program delivery center.

The content server includes an encoder for encoding television signals into H.264AVI signals and converting the H.264AVI signals to HSF signals suitable for transport via IP streaming; and the decoder in each of the STBs decodes the H.264AVI signals and converts the decoded signals to media signals suitable for display on a television. The content server is configured to monitor the rate of receipt of streaming packets at a respective STB, and adjusts the size of the packets to be streamed based on the rate.

A set top box device according to the present invention comprises: a network interface for connecting to the Internet via an access point; a web browser for accessing webpages via at least one preset URL; a buffer for buffering streamed packets of coded media data representing portions of a video program; a processor and software modules for decoding the coded media data, and converting the decoded media data to humanly perceptible audio and video; and a driver for formatting the humanly perceptible video in a format playable on a television, wherein the processor is configured to cause the video program to be played over the television and at the same time downstream portions of the video program are being received at the buffer.

Preferably, the access point is a wireless access point to facilitate wireless access to a remote program center via the Internet at the STB. The software modules include a plugin to receive remote control commands including play, stop, pause, and forward and backward, and the processor is configured to cause the video program to function according to the received commands, and the processor is configured to acknowledge receipt of the packetized media data at a rate proportional to the rate of receipt of the packetized media data. The packets of streamed data are configured as serialized objects with byte sequences identified by markers.

According to still another aspect of the invention, a method of on-demand video delivery is provided, comprising: storing media signals representing humanly perceptible video programs at a program center; converting the media signals into coded media data suitable for streaming over the Internet; establishing at a delivery server an unicast link over the Internet with a set top box (STB) requesting a video program, and streaming the requested video program over the Internet using Internet Protocol (IP); and receiving the requested video program streamed over the Internet at the requesting STB, converting the coded media data to humanly perceptible video, and presenting the humanly perceptible video to play on a television while maintaining communications with the delivery server over the unicast link including receiving packets of downstream coded media data from the respective delivery server.

### BRIEF DESCRIPTION OF THE DRAWINGS

FIG. 1 illustrates an architecture of an Internet Protocol Television (IPTV) system according to an embodiment of the present invention.

FIGS. 2A to 2C show exemplary format conversion methods for handling different source contents in different formats.

FIG. 3 shows major components of a Content Delivery Center according to an embodiment of the present invention.

FIG. 4 shows a content transport system for uploading the encoded contents using the nodelink servers.

FIGS. 5 to 13 show the pages published by a program manager server for access by STBs.

FIG. 14 shows a Distributed Content Delivery architecture to serve a large number of subscribers.

FIG. 15 shows circuit components of a set top box (STB).

FIG. 16 shows the software modules resident in the STB.

FIG. 17 shows an exemplary interface (a remote) usable by the subscriber to select functions at the STB.

FIG. 18 shows the STB configuration page presented to the subscriber when the ‘Setup’ button is selected.

FIG. 19 shows the ‘system upgrade’ page displayed to alert the subscriber that a new version is being upgraded.

FIG. 20 shows a virtual keyboard usable by a subscriber to enter subscriber information when the STB is configured.

FIG. 21 is a webpage presented to the subscriber if the subscriber fails to connect to the Program Manager server with the configuration information.

FIG. 22 shows a page for the subscriber to enter or modify his password information.

### DETAILED DESCRIPTION OF EMBODIMENTS OF THE INVENTION

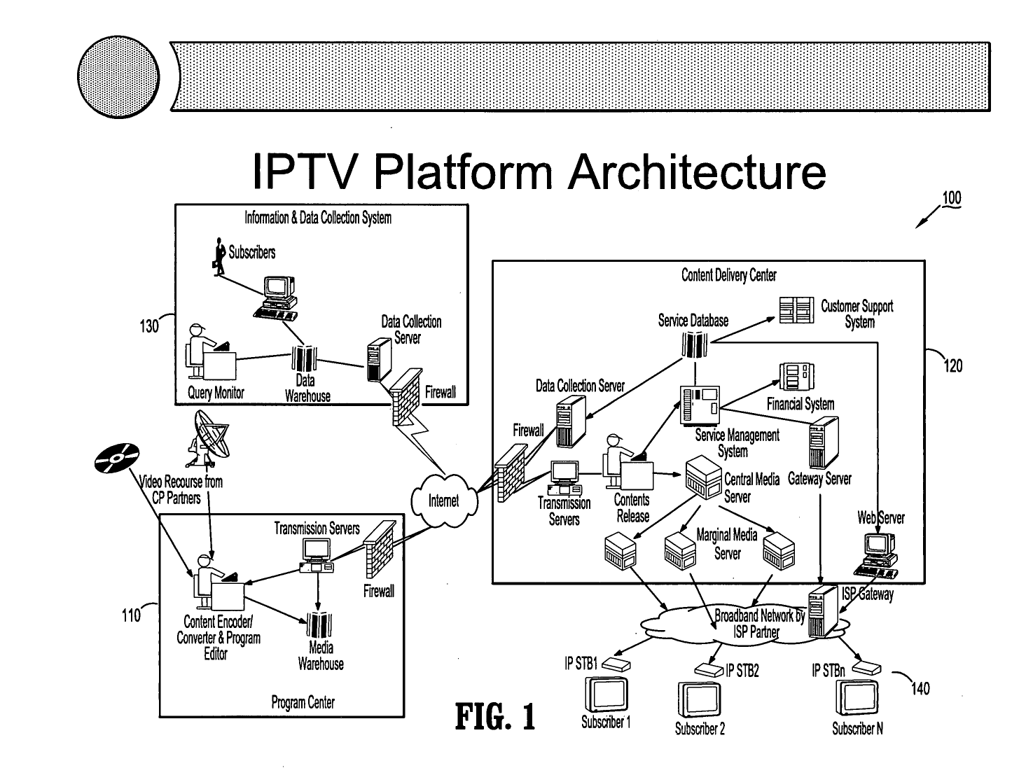

FIG. 1 illustrates an architecture of an Internet Protocol Television (IPTV) system according to an embodiment of the present invention. Referring to FIG. 1, the IPTV system 100 includes a program center 110, wherein source contents in various formats are collected, processed, and prepared for forwarding to a content delivery center 120. The content delivery center 120 prepares and stores the forwarded contents to facilitate retrieval upon request. The content delivery center 120 receives requests for contents from subscribers using Set Top Boxes (STB) 140, accesses the requested contents and delivers them to the STBs 140. In a preferred embodiment, the delivery of the content is by streaming over the Internet, with TCP/IP. The contents can be retrieved by the STBs connected to the Internet via broadband Internet access, such as DSL or cable modem, with transmission bandwidth as low as 500 kbits/sec. The contents received at the STBs are processed and can be output to a television, in interlaced format, NTSC or PAL.

In another embodiment, the delivery of the content may be by downloading, or a combination of downloading and streaming. In this embodiment, the STBs are equipped with a hard disc, or digital video recording (DVR) media, to store the contents delivered at the STB for local viewing by the subscriber. Contents can be downloaded from the Content Delivery Center to the STBs using the Internet Protocol Suite, e.g., TCP/IP, FTP, etc., instead of streaming format.

In still another embodiment, the STBs are equipped to receive the signals from the Content Delivery Center 120 and process the signals for display using a personal computer and monitor.

An Information and Data Collection System 130 is used for collecting and maintaining data on subscribers. This system can be part of the Content Delivery Center 120 or can be disposed remote from the Content Delivery Center 120 and the Program Center 110. The subscribers 140 receive delivery of the requested content using a set top box (STB). The STB is equipped with circuits and stored program modules to interact with the Content Delivery Center 120, to receive the requested content, and to display the content on a television or computer monitor. It can be readily appreciated that with an STB, a subscriber can receive contents from the Content Delivery Center globally, i.e, from anywhere with Internet access.

The Program Center

The Program Center 110 includes a content editor, converter, and encoder to process source contents in various formats, for example, the source content can be from a live television broadcast, from a video camera, from a DVD program, from a videotape such as a Betamax or VHS tape, or from a satellite receiver. The content editor is used to edit the source content prior to encoding. For example, a live broadcast television program may be edited, such as to remove commercials, to add subtitles in different languages, or to include dubbing in a different language, etc. It is preferred that the converter converts the edited or raw sources, in the various formats, to a first common digital compressed form, such as MPEG2. Then, the first common digital compressed signals are fed to an encoder, which encodes the data into a further compressed form, such as MPEG4, with video in H.264/MPEG4 AVC (ISO/IEC 14496-10) and audio in AAC or MP3 (ISO/IEC 14496-3). The H.264 media data can be forwarded to the Content Delivery Center 120 for downloading to subscribers. To facilitate media streaming, i.e., the media is heard and viewed while being delivered, the further compressed data (H.264 compliant) is converted into a file format suitable for streaming, such as Quicktime, Real, MPEG4, Advanced Streaming Format (ASF), e.g., in ASF encapsulated H.264, or a streaming file format that is based on serialized objects which are essentially byte-sequences identified by an identifier or marker (hereafter referred to as “HSF”-H.264 Streaming Format). The media files in HSF are forwarded to the Content Delivery Center 120 for delivery by streaming over the Internet to the subscribers' STBs using a streaming protocol such as Real Time Transport Streaming Protocol (RTSP), Real System, MPEG4, etc.

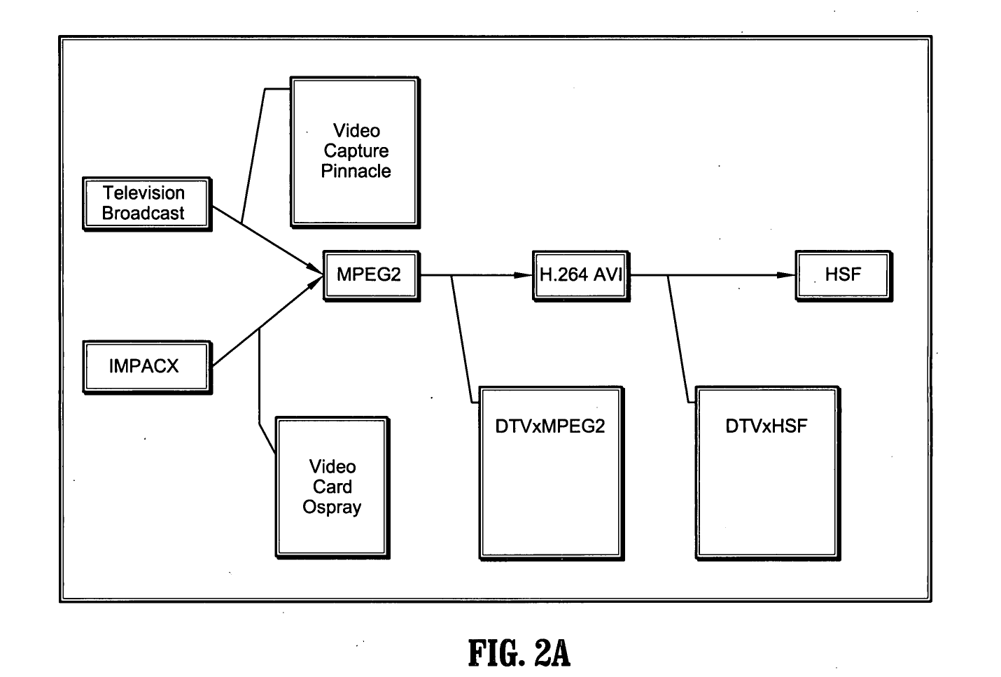

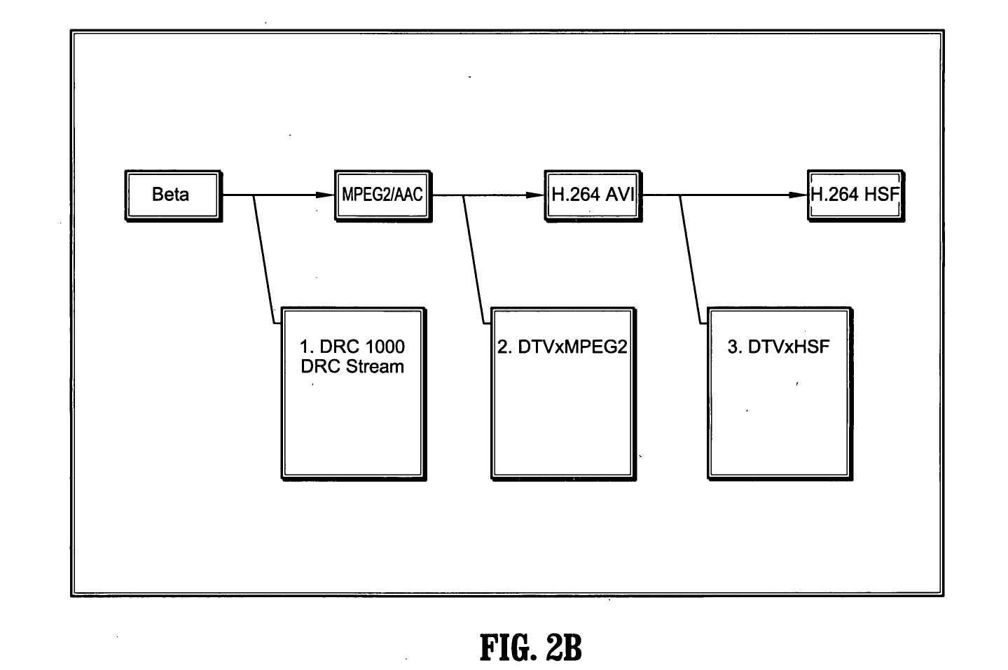

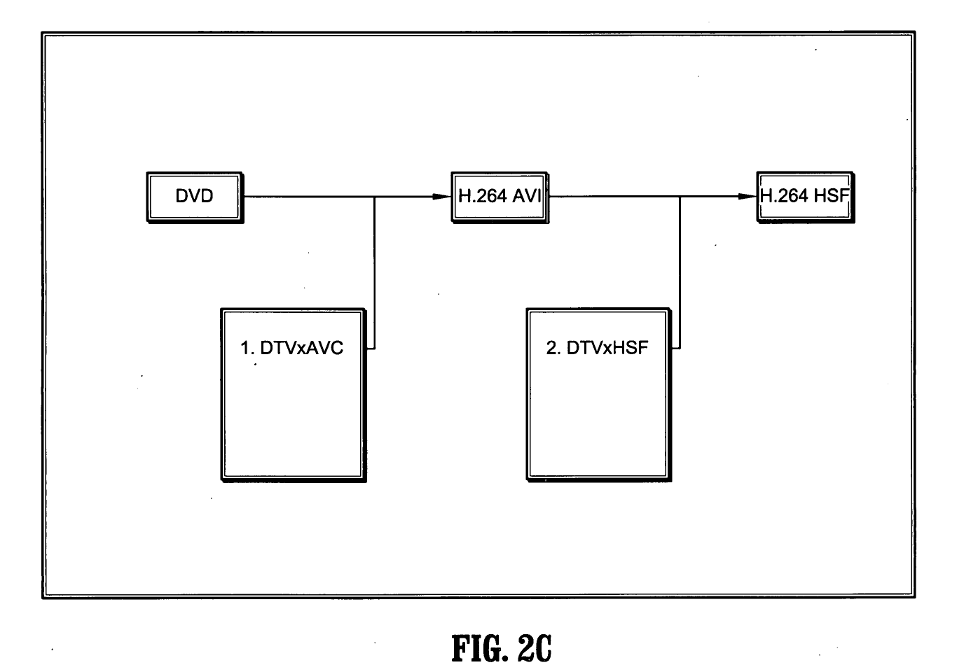

FIGS. 2A to 2C show exemplary format conversion methods for handling different source contents in different formats. FIG. 2A shows the conversion of a television program which is received as analog video signals, such as in IMPAC1, IMPAC2, IMPAC4-ASP, or live television broadcast (TV signals). The TV signals are captured by a video and audio capture card such as the Ospray X00 or with a TV Pro commercially available from Pinnacle Systems. The data output from the capture card can be in digital television DTV format, and then can be compressed in a format the same or similar to MPEG2, which is referred to as a first common media signal, for forwarding to the encoder. The first common media signal data is then encoded using an encoder, preferably object-based, into a further compressed and segmented format, such as Audio Video Interleave (AVI) encapsulated H.264 (“H.264 AVI”) format. To facilitate streaming capabilities, the AVI files are further converted into H.264 Streaming Format (HSF).

The HSF format is based on serialized objects which are essentially byte-sequences identified by markers. Objects representing audio and video files, having characteristics similar to streaming formats, for example, Windows Media Audio (WMA) and Windows Media Video (WMV), and metadata files are included in the HSF files. The metadata is used to reference the content, such as the artist and title of the television program, or in the case of a media program, the album and genre for an audio track, or the director of a video track, etc.

For converting H.264AVI files to HSF files, DirectShow type filters can be used to process the AVI files, including generating corresponding audio channel and video channel InputPins. Objects of the AVI files can be sequenced with markers using a ‘timestamp first’ calculation. For example, the calculation can be:

**if the both audio channel and video channel are not completed, then build the output data frame based on the start time of the data frame**;

**if only the audio channel is completed, then build the output data frames based on the video channel frame sequences**;

**if only the video channel is completed, then build the output data frames based on the audio channel frame sequences**;

**if both audio and video channels are completed, then return, waiting for the next data channel**

To avoid accumulated time differences in audio, audio timestamp correction can be used, e.g.,
corrected start timestamp=((processed audio byte count*1000*1000*10)/audio byte per second)
corrected end timestamp=(corrected start timestamp+((current audio frame byte count*1000*1000*10)/audio byte per second;
start timestamp difference=(corrected start timestamp−start timestamp);
end timestamp difference=(corrected end timestamp−end timestamp);

if either “start timestamp difference” or “end timestamp difference” is not 0, then using the corrected timestamps to replace the original timestamps. Otherwise use the original timestamp.

The filters can be graphed and interfaced with external programs using GUID, e.g.,

DEFINE_GUID(CLSID_TTLHSFWriter,0x6116515d, 0x255f, 0x4e4e, 0x9a, 0x2e, 0xe6, 0x67, 0x4c, 0x0, 0x10, 0xd7);

Preferably, the converted data in HSF is segmented into files that are 8K in size prior to transmission.

The encoder includes plug-ins (such as an API), signal conditioning and other features to convert or encode the first common media signals (such as in MPEG2 format) into a format conforming to H.264/MPEG4 AVC. The encoder includes one or more of the following modules:

Rate distortion optimization (RDO), with adaptive adjustments depending on different sizes of macroblocks.

One pass (constant bit rate (CBR)) or averaging bit rates from multipasses, enhances efficiency and compression ratio.

Half-pixel and quarter-pixel precision for motion compensation, enabling very precise description of the displacements of moving areas.

Multi-picture motion compensation using previously-encoded pictures as references, allowing up to 32 reference pictures (as compared to one or two in prior encoders) to be used in some cases. This feature allows improvements in bit rate and quality in most scenes and in certain types of scenes, for example, for scenes with rapid repetitive flashing or back-and-forth scene cuts or uncovered background areas, it allows a very significant reduction in bit rate.

Adaptation to main profile level 3 and use of Intra (I) and Predictive (P) slices. For example, spatial prediction from the edges of neighboring blocks for “intra” coding.

Variable block-size motion compensation (VBSMC) with block sizes as large as 16×16 and as small as 4×4, enabling very precise segmentation of moving regions.

Weighted prediction, allowing an encoder to specify the use of a scaling and offset when performing motion compensation, and providing a significant benefit in performance in special cases-such as fade-to-black, fade-in, and cross-fade transitions.

An in-loop deblocking filter which helps prevent the blocking artifacts common to other DCT-based image compression techniques.

Adaptive selection between different block sizes such as a 4×4 and 8×8 transform for the integer transform operation.

A secondary Hadamard transform performed on “DC” coefficients of the primary spatial transform (e.g., for chroma DC coefficients and luma) to obtain even more compression in smooth regions.

Context-adaptive binary arithmetic coding (CABAC), which losslessly compresses syntax elements in the video stream, and variable length coding (CAVLC), by itself or in combination with CABAC.

A network abstraction layer (NAL) definition allowing the same video syntax to be used in many network environments, including features such as sequence parameter sets (SPSs) and picture parameter sets (PPSs) that provide more robustness and flexibility.

Switching slices (called SP and SI slices), features that allow an encoder to direct a decoder to jump into an ongoing video stream for such purposes as video streaming bit rate switching and “trick mode” operation. When a decoder jumps into the middle of a video stream using the SP/SI feature, it can get an exact match to the decoded pictures at that location in the video stream despite using different pictures (or no pictures at all) as references prior to the switch.

Flexible macroblock ordering (FMO, also known as slice groups) and arbitrary slice ordering (ASO), which are techniques for restructuring the ordering of the representation of the fundamental regions (called macroblocks) in pictures.

Data partitioning (DP), a feature providing the ability to separate more important and less important syntax elements into different packets of data, enabling the application of unequal error protection (UEP) and other types of improvement of error/loss robustness.

Redundant slices (RS), an error/loss robustness feature allowing an encoder to send an extra representation of a picture region (typically at lower fidelity) that can be used if the primary representation is corrupted or lost. A simple automatic process for preventing the accidental emulation of start codes, which are special sequences of bits in the coded data that allow random access into the bitstream and recovery of byte alignment in systems that can lose byte synchronization.

Supplemental enhancement information (SEI) and video usability information (VUI), which are extra information that can be inserted into the bitstream to enhance the use of the video for a wide variety of purposes.

Picture order count, a feature that serves to keep the ordering of the pictures and the values of samples in the decoded pictures isolated from timing information (allowing timing information to be carried and controlled/changed separately by a system without affecting decoded picture content).

The modules selected for use in the encoder can be further optimized to enhance encoder performance, with improvements in quality and speed. In a preferred embodiment, the RDO module calculation can be performed in less time by use of a ‘Leap Over’ and ‘Test’ process, for example, by use of a reference motion vector or macroblock to measure against macroblocks of varying sizes and reduce macroblock sizes when appropriate to reduce optimization calculations.

Processing speed improvement can also be found in the motion search computation, for example, in the multi-picture motion compensation and half-pixel and quarter-pixel precision motion compensation modules, the use of high speed integer search with hexagonal motion scan and extension to half-pixel and quarter-pixel with diamond scan is found to reduce encoder processing load.

The functions of the encoder are also used to encode still images, e.g., instead of using JPEG to compress still images, the images are encoded as would “I” frames are encoded using H.264 encode functions. It is found that such encode of still images can be at a compression rate much higher than JPEG, e.g., the compressed image using H.264 is in the order of about 50% in size of a compressed image using JPEG.

The above processing avoids use of the bidirect ‘B ’ slices to reduce process load. Other optimization techniques employable include use of Multimedia Extensions MMX, Streaming SIMD Extensions SSE, and SSE2 etc. for Intel-type CPUs.

Further and more detailed descriptions of a codec optimized for IP television can be found in US patent application, “Codec for IPTV”, Ser. No. ______, (attorney docket no. 8126-2), filed on May 12, 2006, the disclosure of which is incorporated by reference herein. It has been found that the modules and optimization processes employed by the encoder perform significantly better than a basic (non-optimized) MPEG4 encoder, by up to 50 times faster in speed in the encode process. The conversion and encode process provides D1 resolution pictures at real-time, with less than 30 seconds latency compared to live television. Preferably, the video encoder employs a multiprocessor power architecture, capable of real-time D-1 (720×576) or VGA (640×480) H.264 encoding and up to 10 mps output. The D-1/VGA/processing is preferably at 30 frames per second (NTSC) or 25 FPS (PAL). Black fillers can be used at the edges of a VGA resolution output to provide a modified sized picture, such as to conform to NTSC resolution.

A speed optimized encoder and decoder according to the present invention facilitates the play of humanly perceptible video on a television while signals representing downstream segments of the video are continually being received at the STB. Further, real time play of the humanly perceptible video on the television using a DSL connection at as low a bandwidth capacity of 500 Kbps can be achieved.

FIG. 2B shows the conversion and encode process for a Betamax videotape source. A DRC 1000/1500 is used to convert the Betamax tape output signals to MPEG2 video and Advanced Audio Code (AAC) audio signals. The encoder encodes the MPEG2 and AAC signals into AVI encapsulated H.264 (H.264 AVI”) and then HSF encapsulated H.264 (“H.264 HSF”), essentially as described above.

FIG. 2C shows the convert/encode process when the source content is in DVD format. Typically, contents in DVDs are already encoded in MPEG2 video and AAC or MP3 audio. Thus, the encoder is used to encode the DVD signals to H.264 AVI and then to H.264 HSF.

The edited, converted, and encoded content can be stored in the media warehouse in Program Center 110 or forwarded to the Content Delivery Center 120. Transmission servers, employing TCP/IP and File Transfer Protocol (FTP), transfer contents of the media warehouse to the Content Delivery Center 120 over the Internet. Alternatively, the encoded content can be burned-in onto a recording medium, such as a DVD, and the DVD with the encoded content (in H.264 AVI or HSF) can be transported to the Content Delivery Center 120 via courier. If the content of the DVD program, such as a recent release movie, is to be streamed to a subscriber who requested a Video On Demand (VOD), the H.264 HSF files are stored. If the movie is to be downloaded to a DVR in the STB for viewing locally by the subscriber, the H.264 AVI or HSF files are stored.

The Content Delivery Center

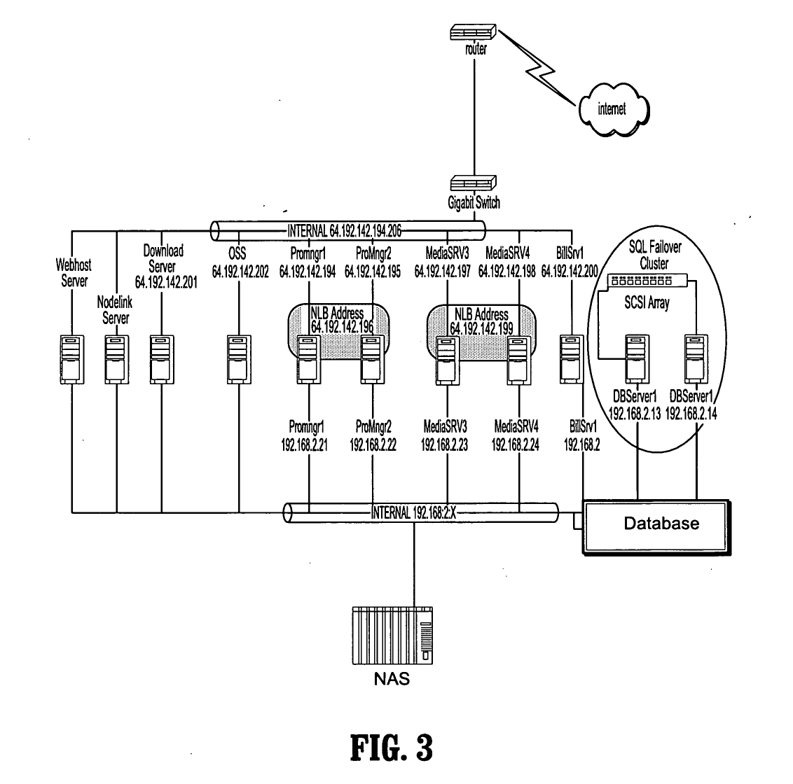

FIG. 3 shows the major components of the Content Delivery Center 120. A network attached storage (NAS) is a large capacity storage device which can be used to store the encoded media files forwarded from the Program Center 110. The NAS is connected in a local area network (LAN) to several servers and a Database. The servers connected to the LAN include the Database Server for serving the Database; a Streaming Server for accessing the encoded contents in the NAS and streaming the content to a subscriber who requested a program; a program manager server; a download server for downloading encoded contents (e.g., in H.264 AVI or HSF) to STBs equipped with hard-drives or DVRs; a nodelink server for uploading or receiving encoded contents forwarded from the Program Center 110; a bill server for processing billing information; and an Operation System Server (OSS) serves administrative and management functions for the Content Delivery Center 120 and the set top boxes (or subscribers). The servers are also connected to an external network via a gigabit switch and a gigabit router over the Internet to the STBs and the corresponding subscribers 140. Servers shown in FIG. 3 in duplicates denote the use of redundancy architecture to ensure fail-safe operations, with minimal interruptions due to a down server. Unless specified otherwise, each of the listed servers uses an operating system like the Microsoft Windows 2003 Server or Linux server, a Pentium IV processor, large capacity disk and SDRAM storage, and a 100M Ethernet NIC.

The Nodelink Server

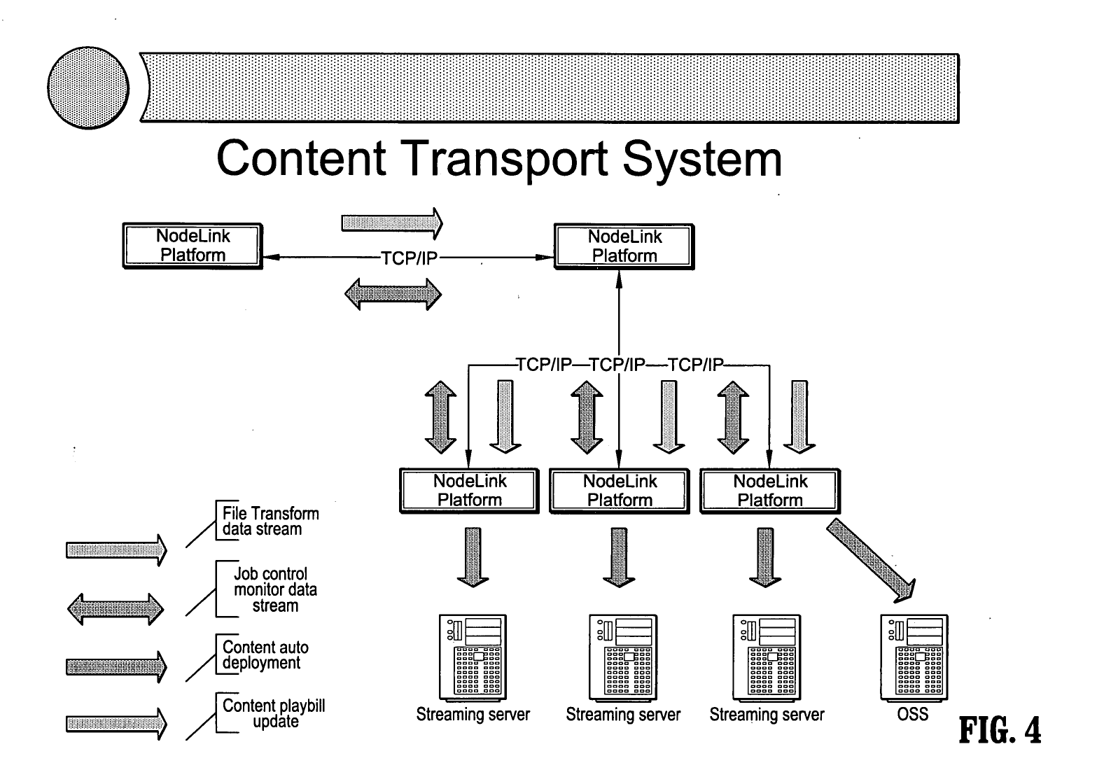

FIG. 4 shows the content transport system for uploading the encoded contents using the nodelink servers. The nodelink servers are compatible with the transmission servers in source 110. Preferably, the same hardware and software components are used at the nodelink and the transmission servers (110 of FIG. 1). Using TCP/IP, FTP, the files are forwarded from the transmission server to the nodelink server. The files to be forwarded are first segmented into smaller files. For example, if the file to be forwarded is in the order of gigabytes, the file is segmented into smaller files, in sizes of about 3 Mb to about 28 Mb, prior to transmission from the transmission server. The segmented files are given identification that they are parts of a larger file, e.g., they are given different IDs but same file names to identify them as segments of a larger file. The segmented files are preferably transmitted using TCP/IP and FTP to the nodelink servers. The nodelink servers reassemble the segmented files back into the original larger file. The contents received by the nodelink server can be stored, e.g., with media files in the NAS and metadata in the Database, or the contents can be sent directly to the Streaming Server for streaming to the subscriber. Upon completion of uploading programs, e.g. 8 hours of various programs from several channels of live broadcast, the metadata is examined by the OSS server and a playlist, or daily program guide, is created and forwarded to the program management server to present to the subscribers. Preferably, the nodelink server employs the Redhat Linux 9 operating system. An exemplary transmission server and nodelink server uses a Pentium IV, 3.3 G processor, has 512M in SDRAM, and has at least 120 GB disk drive. As an example, to upload a live broadcast, the source material received from a television broadcast is recorded, edited, and/or programmed.

The OSS Server

The OSS server performs administrative and management functions at the content delivery center 120. The OSS server coordinates use with the Database Server, the program management server, and the billing server in performing the OSS functions. The OSS server includes modules for system management, partner management, content management, customer management, customer services, and billing management. The functions performed by these modules include: receiving periodic reports of programs uploaded from the program center 110 and publishing an updated program guide to subscribers contemporaneously. For example, each morning the OSS server constructs a playlist of programs such as live broadcasts or new release titles for video on demand and publishes the playlist to the subscribers via the program manager server; providing customer services, customer support, help desk and correspondence with customers via email, etc.; systems and network management; subscriber profiling and account management; and managing billing functions using the billing server.

Preferably, the OSS server uses an operating system like the Microsoft Windows Server or Linux server, a Pentium IV processor, large capacity disk and SDRAM storage, and a 100M Ethernet NIC.

The Web Hosting Server

The web hosting server provides a web server for the IPTV content provider, i.e., it hosts a home website at a designated URL (e.g., www.kylintv.com) for the IPTV content provider. The content provider's home page on the web for the IPTV content provider is accessible from any computer using HTTP at the specified URL over the Internet. Objects are placed on the home page which allows a user having a browser to enroll as a subscriber, to hyperlink into information about the content provider, products provided by the content provider, and subscriber (member) account access, etc. A program guide or programs available can also be accessed through a hyperlinked object. Correspondence with the content provider by e-mail can also be made. When a subscriber wishes to access his account information from the content provider's web page, the web hosting server will authenticate the subscriber with previously signed on password information and if authenticated, accesses the Database Server and database to access information stored therein for the requesting subscriber.

This server uses an operating system like the Microsoft Windows Server or Linux server, a Pentium IV processor, large capacity disk and SDRAM storage, and a 100M Ethernet NIC.

The Program Manager Server

The Program Manager server is another web application server, but different from the web hosting server, this web application server is to serve as access to contents by the subscribers through the set top boxes (STBs). The Program Manager web application server provides a home page to welcome the subscribers. The homepage has hyperlinked objects for selection by-the subscriber. When a STB is turned on and properly configured, the homepage will appear automatically as the STBs are preset to point to this homepage (The STBs are configured and equipped to connect to the Internet with a browser).

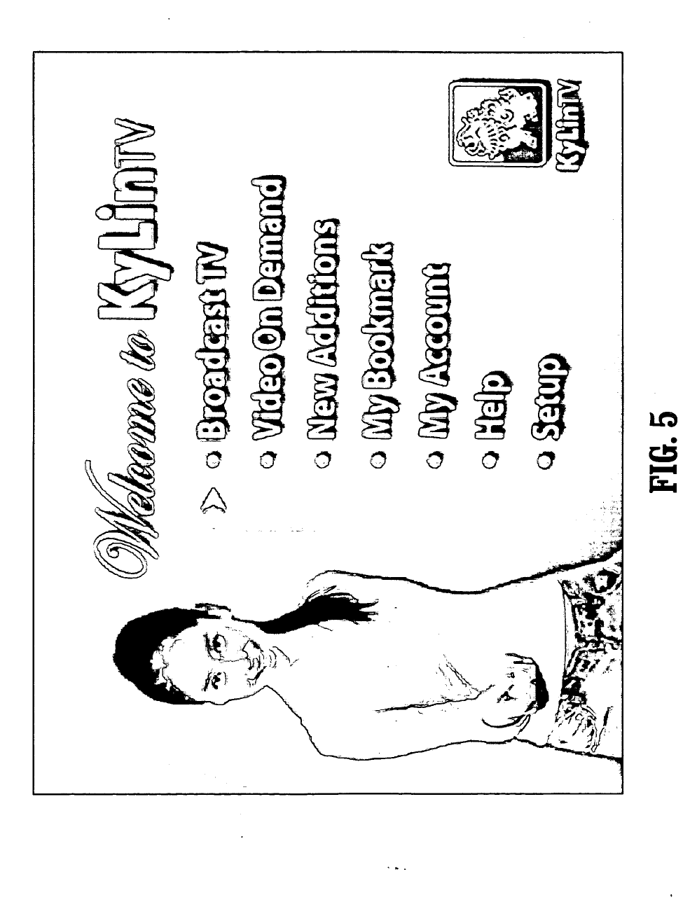

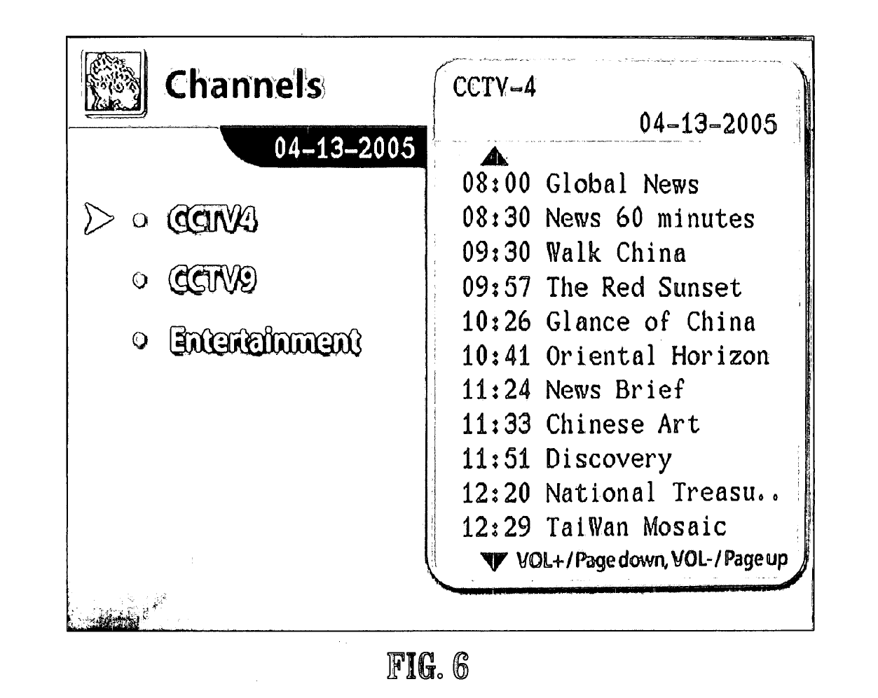

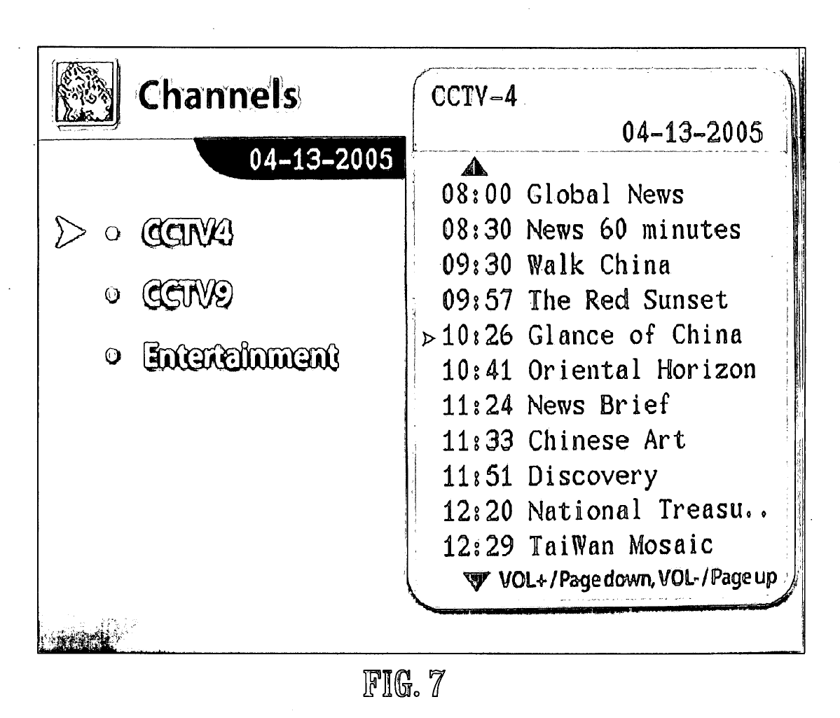

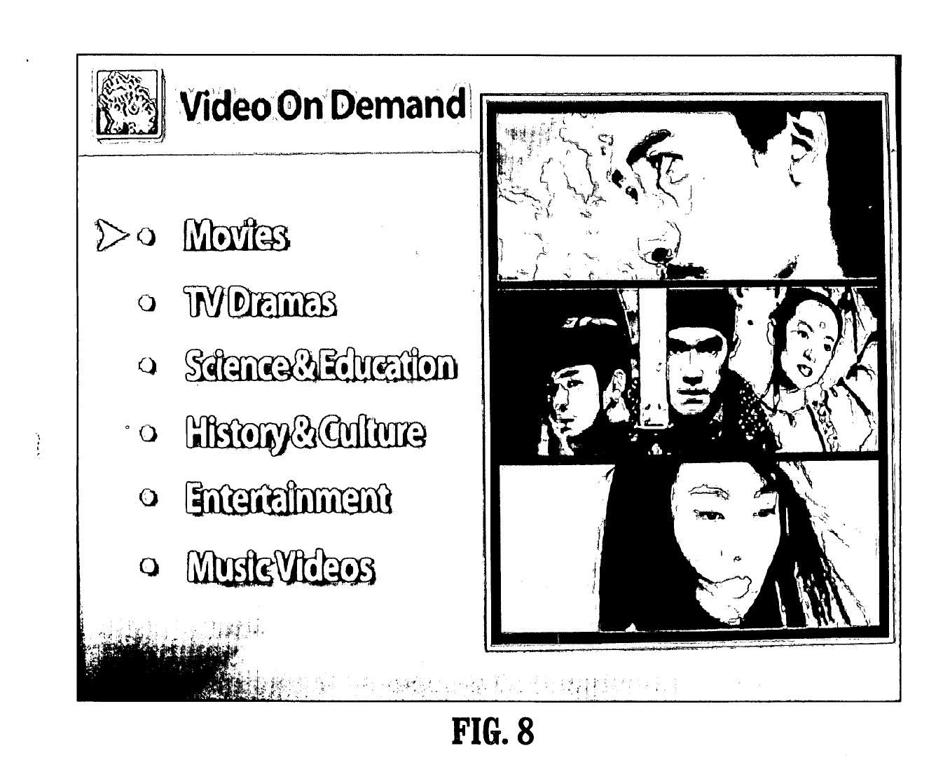

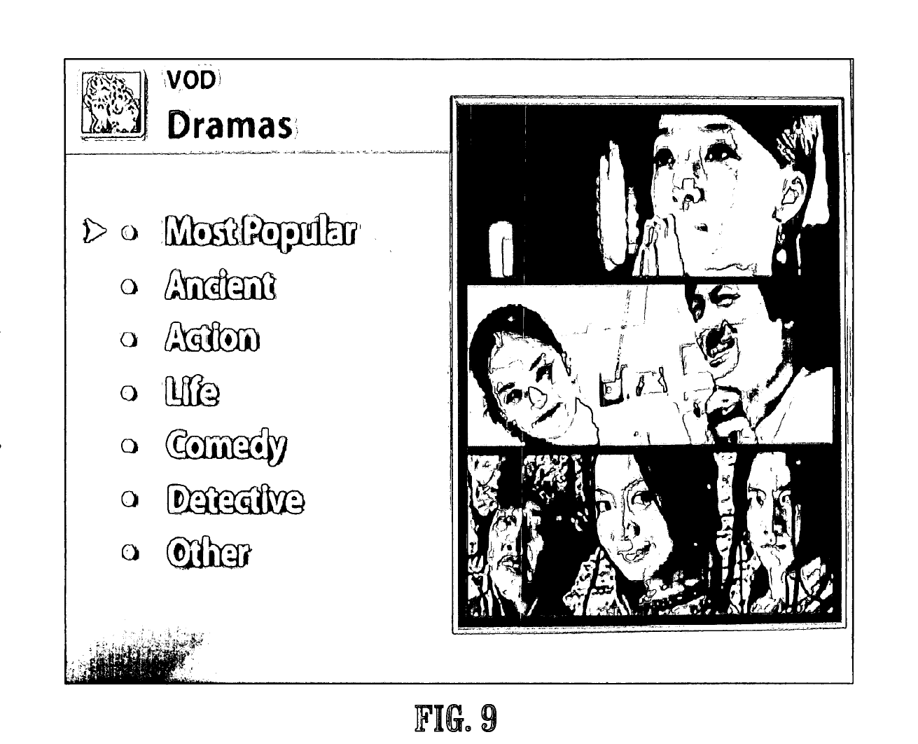

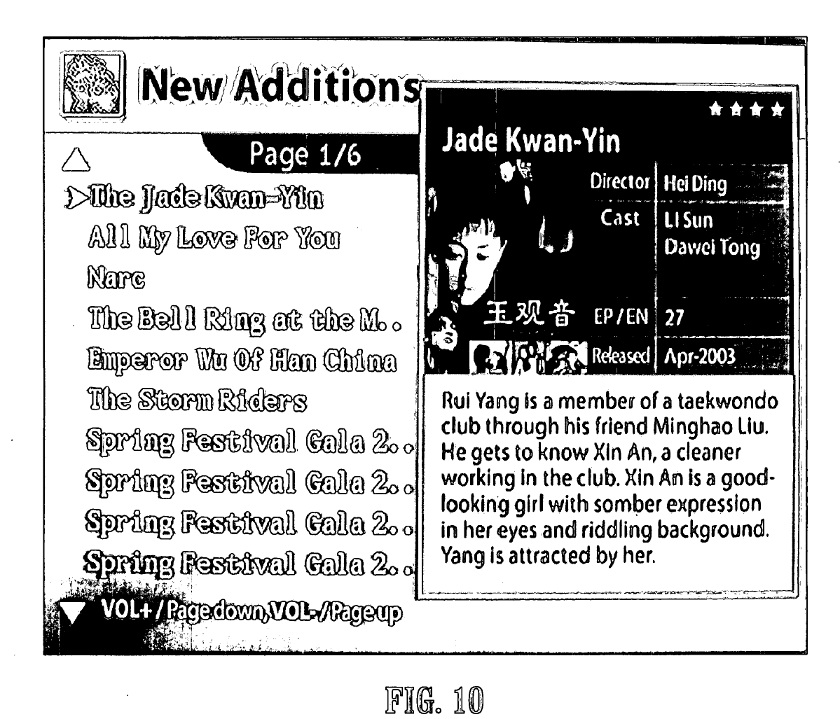

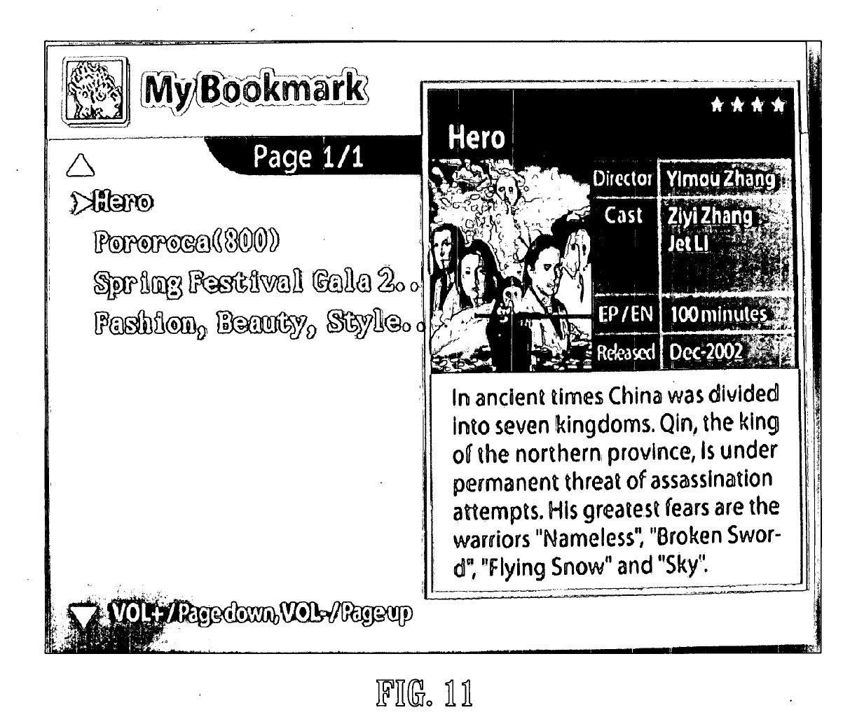

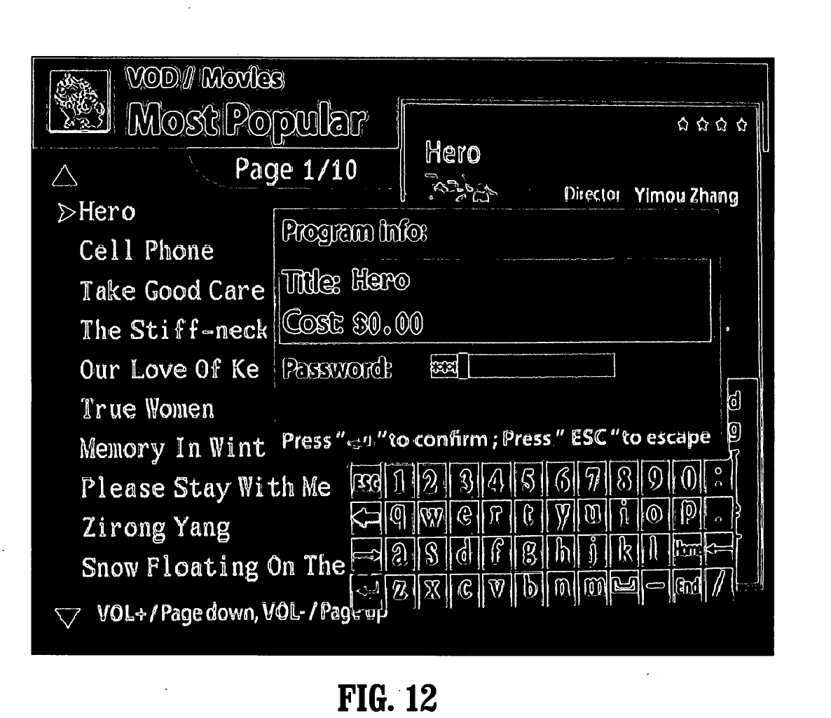

The Program Manager can personalize the home page based on the user's personal information. For example, it can greet the user with her first name and/or last name, and based on user's preference, subscription packages and viewing patterns, notify the user what new programs may interest him. (The STBs will be further described below). FIGS. 5 to 13 show the pages published by the program manager server for access by STBs. FIG. 5 shows an exemplary welcome homepage as displayed on a television monitor connected to the STB. The hyperlinked objects on the homepage allows the subscriber to choose programs from “broadcast TV”, “video on demand”, “New Additions”, “My Bookmark”, “My Account”, “Help” and “Setup”. The first three objects are selected to access contents. When the subscriber selects the “Broadcast TV” option, the playlist created by the OSS server published on the Program Manager server is shown (FIG. 6). It can be seen that a list of programs are presented for selection by the subscriber. The subscriber can scroll through the playlist or program guide to browse or view the selected program. (FIG. 7). If the subscriber chooses “Video On Demand” from the home page (FIG. 5), video programs of various topics are presented (FIG. 8). Here, topics such as “Movies, Tv Dramas, Science and Education, History and Culture, Entertainment, and Music Videos” are available for selection by the subscriber. When the subscriber selects Tv Dramas (FIG. 9), the subscriber is presented with different categories such as “Most Popular, Ancient, Action, Live”, etc. FIG. 10 shows when the subscriber selects the “New Addition” programs from the home page. Here, the more recent releases in movies or current popular programs are presented for selection. FIG. 11 shows a page presented when the subscriber selects “My Bookmark” from the home page. This selection is for subscribers to return to programs previously selected and partially viewed by the subscriber. Whenever a subscriber chooses to access a program for viewing, the Streaming Server is contacted to handle the delivery of the content. FIG. 12 shows when a subscriber has chosen a video program for viewing. A dialog box is presented to the subscriber to show the cost of the program and the title of the program to be purchased along with an object for the subscriber to enter his password. The video program is accessed and delivered to the STB when the subscriber is authenticated and the subscriber confirms the request.

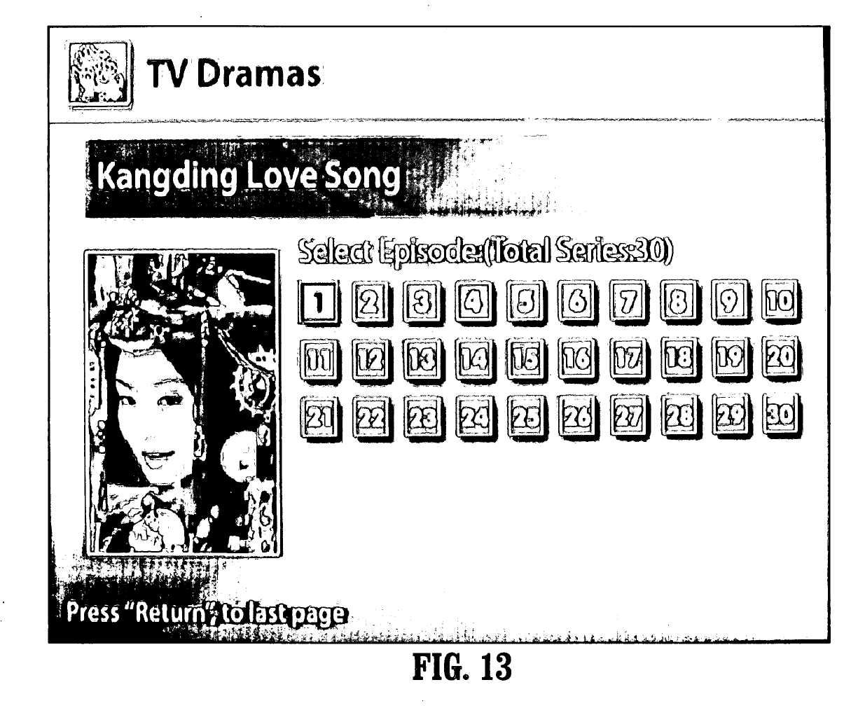

With the ‘My Bookmark’ feature, the subscriber can stop play in the middle of a paid VOD program and return to the program where he left off when stopped. For this feature, the Streaming Server plugin recognizes a ‘stop’ command from the subscriber and at that time, records the title and frame of the VOD program. A record is created and sent to this subscriber's area in the Database. With the ‘My Bookmark’ feature, a subscriber does not have to sit through a paid VOD program and can view the remaining portion of the program at anytime. FIG. 13 shows when a drama (series) is selected, the 30 segments are made available for selection and the segment previously viewed and bookmarked is grayed (segment 4).

The Program Manager server is preferably equipped with an operating system like the Microsoft Windows Server, or Linux server, a Pentium IV processor, and large capacity disk storage, such as 120 GB and a 1G SDRAM, and a 100M Ethernet NIC.

The Streaming Server

The Streaming Server is responsible for handling delivery of contents to STBs on demand. A Plugin to the Streaming Server authenticates STBs and subscribers before delivery of content, creates a record for book marking, and creates a record of the transaction when there is a sale. The delivery of content using the Streaming Server is by streaming. The Streaming Server takes over from the Program Manager server the interfacing functions with the STB when a demand is made for content. For example, upon entry and receipt of the password from a subscriber demanding a video program, the Streaming Server is alerted to authenticate the subscriber against the subscriber's profile information stored in the Database. When the subscriber profile is accessed, the media access control address (MAC address) pre-associated with each STB and the subscriber sign-on information entered when the subscriber signed on is accessed from the Database. The MAC address, along with the subscriber and his password is matched for authentication. Upon authentication, the Streaming Server retrieves the requested program from the NAS and starts streaming the program for viewing by the requesting subscriber. A point-to-point thread or link is maintained between the Streaming Server and the STB receiving the content. The Streaming Server streams the encoded HSF files retrieved from the NAS into the STB, which in turn receives and decodes the files for display in NTSC or PAL, i.e., the program is viewed by the subscriber as the file is continually streamed to the STB. The Streaming Server Plugin responds to STB commands such as STOP, frame Forward, Pause, and Reverse and adjusts the frames accordingly to effect the commands on the subscriber's monitor. The Plugin also records the frame information when a STOP command is received. The title and frame stop information is stored and later retrieved whenever the subscriber desires to resume view of the program. The Plugin also records the transaction of the purchase and the record is sent to the Database Server and database for storage in the subscriber's area associated with billing.

According to a preferred embodiment of the present invention, a progressive streaming server varies the packet size of the files to be downloaded depending upon the bandwidth availability of the receiving STB. The bandwidth availability can be either detected or reported. For example, the Streaming Server monitors the rate of acknowledgement of receipt signals returned from the STB to access the bandwidth availability of the STB. If the STB is seen to have a heavy processing load or the rate of acknowledgement is slow, the Streaming Server, e.g., the NodeLink Kernel decreases the size of the packets to be sent, thus slowing the rate of transfer. If the STB is seen as available, e.g., the rate of acknowledgement is high, the packet size is increased. In certain instances such as when the buffer in the STB already has data needed to feed continual play of the media program, and the rate of acknowledgement is still high, streaming at higher packet rates continues to fill the buffer, for example, with ‘look ahead’ data, which can be subsequent media content to be played or other content. The progressive streaming process can vary the packet size, for example, between 1K to 32K, but preferably, between 8K to 24K. With the buffer in the STB continually streamed with media content, the program can be presented from the STB to the subscriber whenever requested by the subscriber, much like from a Digital Video Recorder (“DVR”) or a DVD player. Preferably, the buffer in the STB has storage capacity of 4 MB to 16 MB, but preferably at about 5.5 MB, for buffering both video and audio data, which allows buffering of 10 to 60 seconds of content at 30 fps rate of display. According to this embodiment, each of the Streaming Servers is equipped with a high performance CPU, such as 4 Intel XEON, with 2G SDRAM, 146 GB disk, with a 100M or 1000M Ethernet NIC, running an operating system with clustering and fault tolerant capabilities.

Distributed Content Delivery Architecture.

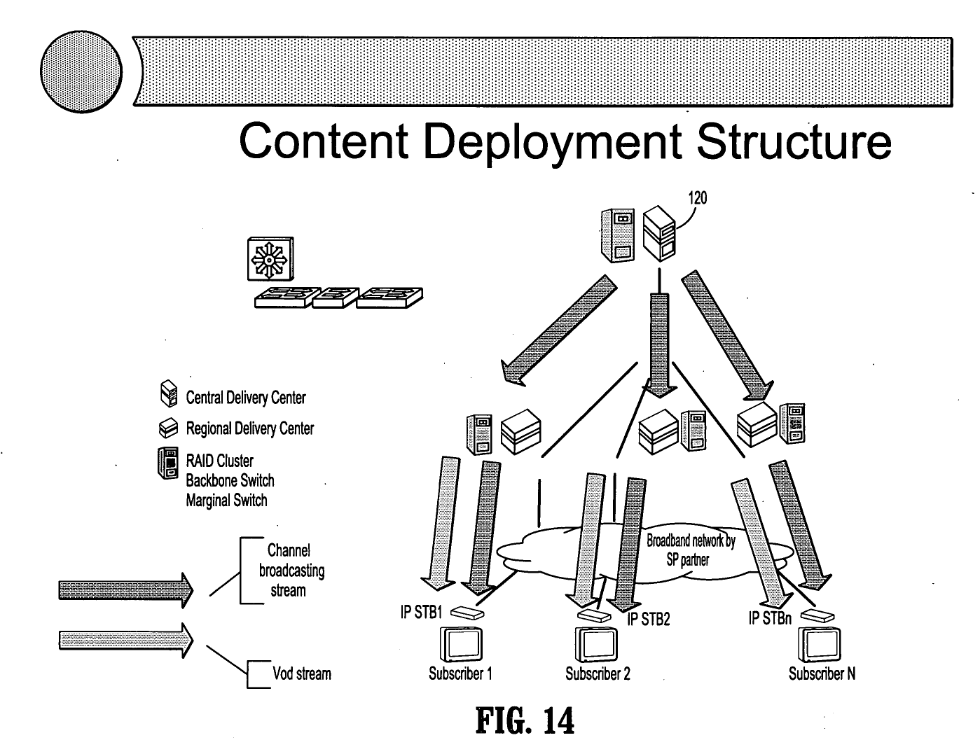

FIG. 14 shows a Distributed Content Delivery architecture to serve a large number of subscribers. The architecture comprises a number of Regional Content Delivery Centers which receive content from the central Content Delivery Center 120. Each Regional Content Delivery Center includes at least one Program Manager Server, NAS, database server, Nodelink Server, Download Server, and Streaming Server and provides content to a plurality of subscribers in that region. Thus, the architecture supports concurrent streams. In a preferred embodiment, the Regional Content Delivery Center authenticates and confirms subscribers within its region and the transaction information for purchases are forwarded to the Central Content Delivery Center 120 for billing and subscriber profile purposes. Tests have shown a 1000M Ethernet NIC supports 716 concurrent streams at 35% utilization.

The Billing Server

The billing server, upon command from the billing module in the OSS server, accesses the usage information from each subscriber's account. The billing server tabulates the costs and the number of programs purchased by the subscribers and prepares bills for forwarding to subscribers.

The content provider can access the Database from time to time to view subscriber profile and viewing experience information to better understand its products and subscribers. The content provider can then offer different contents or different business or billing models to better fit its customers. For example, if the content provider finds that there is more incentive to purchase if there is available unlimited VODs for a fixed maximum monthly fee, it can be offered to enhance sale and subscriber loyalty.

Billing Models

Different billing models can be set by the content provider using the OSS, database, and billing servers. The content provider can offer a variety of packages in single or combination programs at varying price points for selection by subscribers. For example, a monthly subscriber fee is charged for basic subscriber access, such as unlimited free viewing of two channels of broadcast programs from China (e.g., Channels CCTV4 and CCTV9, in Chinese and in English, respectively), with a daily updated program playlist selectable by the subscriber (see FIGS. 6 and 7). The video on demand programs, either movies or dramas, can be purchased at a fixed price. In another package, movies are charged per movie and dramas (or series) can be charged by the entire series or at a (reduced) price per segment. From the sale transaction record captured by the Streaming Server plugin and forwarded to the Database, the purchases can be tallied and billed periodically. To activate the unlimited view, maximum fixed price model, the billing server is programmed to not bill the subscriber in excess of the fixed maximum monthly price even if the total purchases exceed the maximum.

The Download Server

The Download Server is responsible for downloading video programs to STBs equipped with digital video recording (DVR) storage. The contents to be downloaded are encoded media data in either AVI or HSF. An intelligent bandwidth-adjustable download process is employed. In such process, the packet size of the files to be downloaded is varied depending upon the bandwidth availability of the receiving STB. The bandwidth availability can be either detected or reported. For example, the Download Server can monitor the rate of acknowledgement of receipt signals returned from the STB to access the bandwidth availability of the STB. If the STB is seen to have a heavy processing load or the rate of acknowledgement is slow, the Download Server decreases the size of the packets to be sent, thus slowing the rate of transfer. If the STB is seen as available or idling, e.g., no program is being viewed, the packet size is increased and the content can be downloaded in a shorter time. The packet size can vary, for example, between 1K to 20K, but preferably, between 1K to 7K. With the content stored in the STB, the program can be presented from the DVR storage to the subscriber whenever requested by the subscriber, much like from a DVD player.

The Download Server also provides Digital Right Management (DRM) functionality to protect the downloaded media contents. According to one embodiment, the Download Server encrypts the content based on the information that can uniquely identify the STB, such as the MAC address, such that the downloaded content can only be viewed on that particular STB. The Download Server transfers the encrypted content to the STB and stores the content in encrypted format on the STB so that the user cannot further transfer the downloaded content to another STB or to a PC, or even if the media can be transferred, the media cannot be properly viewed.

The Set Top Box (STB)

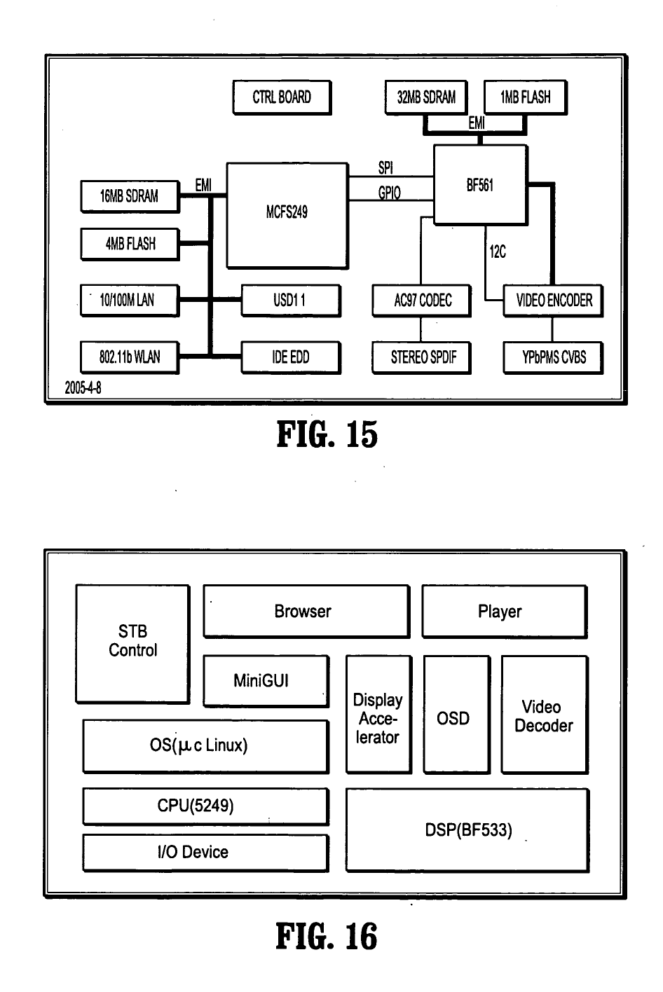

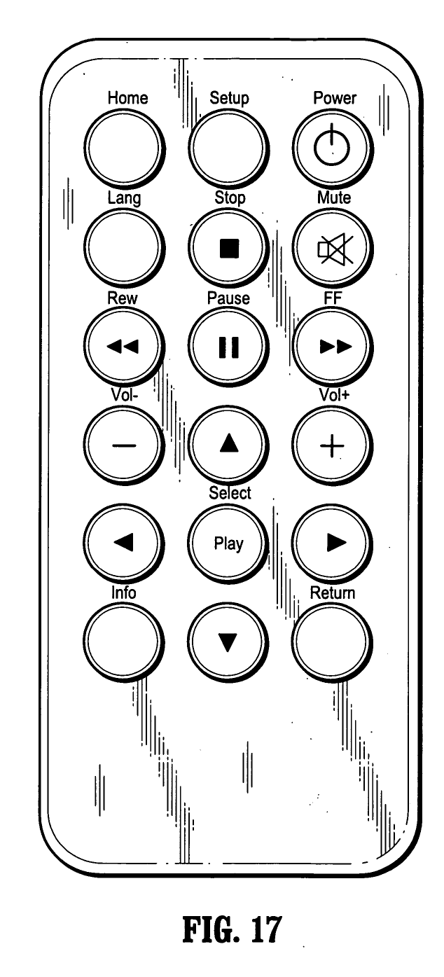

FIG. 15 shows the circuit components of a set top box (STB) and FIG. 16 shows the software modules resident in the STB. FIG. 17 shows an exemplary interface (a remote) usable by the subscriber to select functions at the STB.

Referring to FIG. 15, the STB includes a CPU, CPU memory, network card, media player, and various drivers. A Digital Signal Processor (DSP-BF533 or BF561, available from Analog Devices Inc.) processes the media signals. Decode and signal processing software is resident in the Flash memory connected to the DSP. A SDRAM connected to the DSP is to serve buffering functions. An audio codec is used to play audio files such as ACC or MP3 over television and home theater audio equipment. A video decoder converts the H.264 encoded video media signals into component or S video outputs to the television monitor. The network card interfaces with a 10/100M LAN or a wireless LAN, and facilitates wired or wireless communication with an access point such as a cable modem or DSL input. The wireless LAN facilitates convenient placement of the STB proximal any television, allowing video program viewing at proper television settings.

Referring to FIG. 16, the software modules of the STB include decoder, operating system software, STB controls, device and I/O drivers, browser, media player, miniGUI, display accelerator, on screen display, network interface software for LAN or wireless LAN (WLAN), video and audio decoders, and signal processing and DSP interface codes. The operating system can be Linux or Windows. The media player includes software capable of playing the decoded media signals in various forms, such as broadcast media, video-on-demand programs such as a movies or dramas, or play from DVR stored programs. The media player is also equipped to process commands such as in a DVD or VCR player for stopping, pausing, forwarding, or reversing the program being played during VOD or DVR play. The commands can be received from a Remote Control described below.

The decoder performs H.264 decode functions including inverse motion compensation, inverse transform (IDCT), loop filtering, coefficient entropy decode (e.g., CAVLC or CABAC decode), buffering, etc. Processing optimization, similar but in reverse order from those described for the encoder, can be employed to achieve speedier decode. The decoder includes DSP porting and interfacing routines for interfacing the DSP. Audio and video synchronization routine is employed to synchronize the audio signals with the presented video signals. This routine preferably includes means for monitoring the video signals as they are presented and makes adjustments to the audio signals to ensure that the video frames and the audio signals are in sync. For example, when the routine detects video frames having large processing load, the audio signal is delayed by the extra time needed to process the video signal. The still images encoded by the encoder using H.264 are decoded by the H.264 decode functions and the decoded still pictures can be published by the program manager server for viewing using an STB.

The software modules of the STB facilitate receipt, including buffering, of the H.264 HSF files streamed from the Content Delivery Center. When the STB is connected to an Internet access point with a bandwidth of about 500 Kbyte or greater, such as with a cable or DSL modem, video programs can be displayed at a television (NTSC) monitor connected to the STB nearly continuously with minimal buffering interruption. The received files are decoded by the decoder.

In an alternative embodiment, an STB is provided for presenting the contents using a personal computer and monitor. In such STB, a media player plugin is provided for handling functions of the media player described above, but the functions are in connection with presenting the content materials on the computer monitor. In this embodiment, the encoder further includes multimedia optimization features such as MMX extension, SIMD with streaming features, e.g., SSE and SSE2 instructions for Intel Pentium type processors.

The encode and decode functions are further described in a related provisional patent application, attorney docket 8126-2, entitled CODEC FOR IPTV, filed concurrently with the present provisional application. The disclosure of the 8126-2 application is incorporated by reference herein.

FIG. 17 shows a remote control usable by a subscriber to control the STB. When the ‘Home’ button is selected, the STB is returned to the home page URL preset at each STB (see FIG. 5), from which the subscriber can select programs including live broadcast or VOD. The bottom set of nine buttons include cursor pointers and a ‘Play’ or Select button. The ‘Return’ button is pressed to return to the previous URL page accessed by the subscriber. The ‘Info’ button, when pressed, presents a page with information about the program selected. The ‘−’ and ‘+’ buttons are for volume control. The top nine buttons are program control buttons ‘Stop’, ‘Pause’, ‘FF’ for fast forward, and ‘Rew’ for rewind of a program being viewed. A ‘Lang’ button is used to select the language of the text to be presented. For example, if broadcast and video programs from China are offered, Chinese and English texts are selectable by use of this button. If programs are from Latin America, Spanish and English texts are selectable. The ‘Setup’ button is used when the STB needs to be configured or reconfigured to the network, or to manually (as opposed to automatically) download new or updated versions of software. A virtual keyboard appears on screen when text information needs to be input. The STB can also be interfaced with other interface equipment such as a keyboard. A PS2 or USB connector output is available from the STB for connection by a keyboard to effect the selections as described above. The use of an actual keyboard would allow speedier text input when needed.

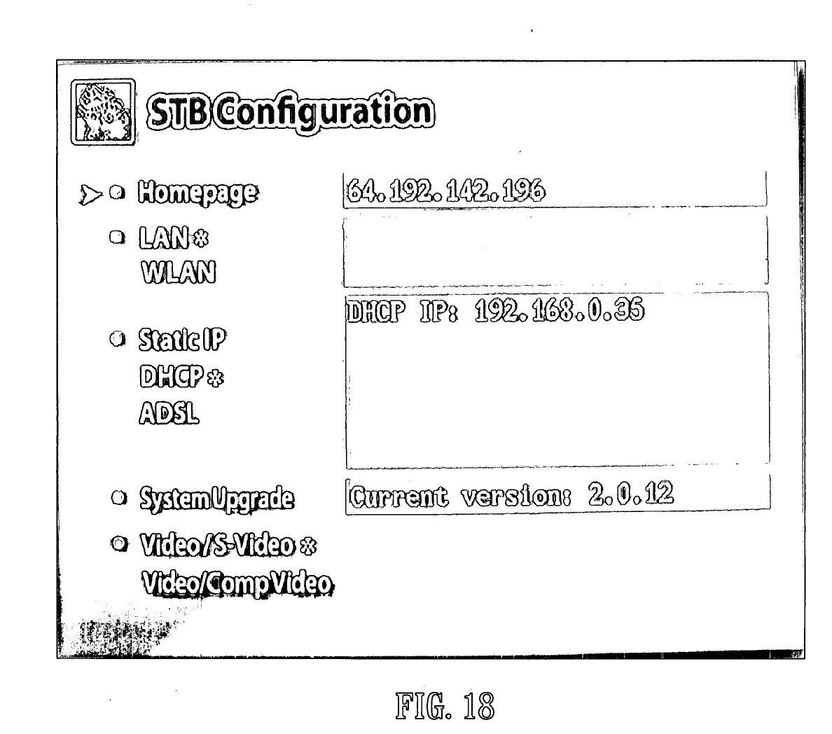

FIG. 18 shows the STB configuration page presented to the subscriber when the ‘Setup’ button is selected. The subscriber scrolls the menu that appears on the left using the cursor buttons of the remote or a keyboard. The STB is factory set to access the pre-assigned URL (e.g., home.kylintv.com) published by the program manager server at the Content Delivery Center. The subscriber can then fill in the LAN or wireless LAN information depending on whether the STB is connected to an Internet access point via a LAN or a WLAN. The STB can receive the programs requested by the subscriber and smoothly display same if the STB is connected to broadband access, such as DSL or cable modem, with at least a 500 Kbyte bandwidth. Various internet protocol access configurations are selectable, for example, ‘Static IP’, ‘DHCP’ or dynamic host configuration protocol, or ‘ADSL’ for IP access via DSL. When ‘System Upgrade’ is selected, the current version of software running in the STB is displayed. The subscriber can upgrade to a newer version by this selection. The STB video output can be selected between ‘S-Video’ or ‘Component Video’ output.

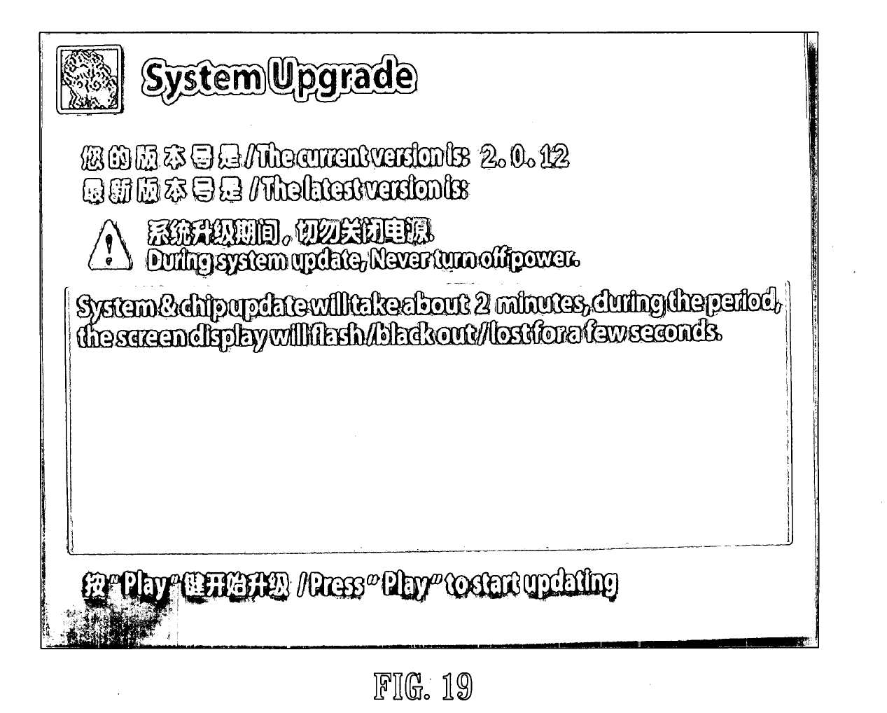

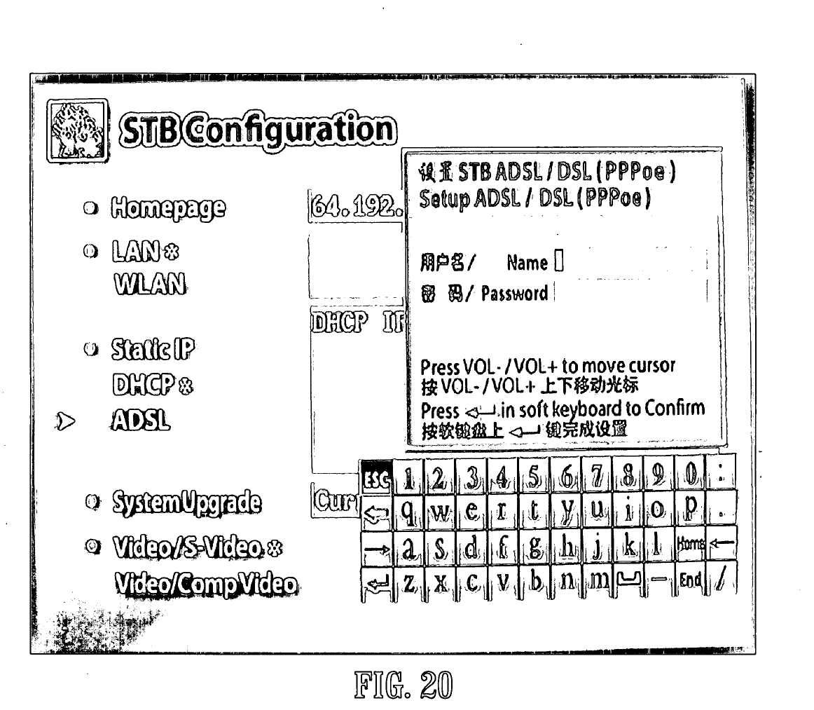

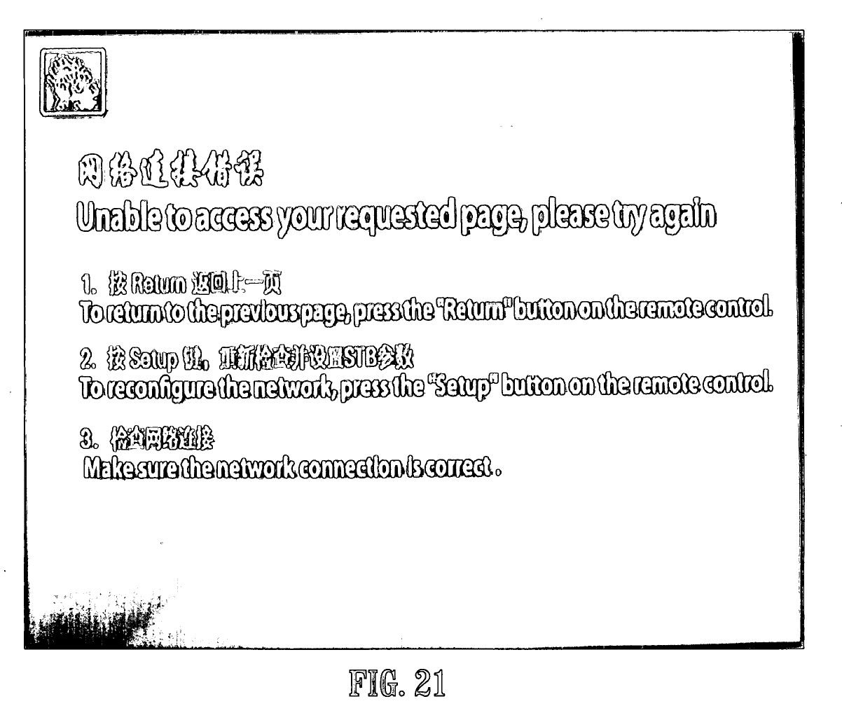

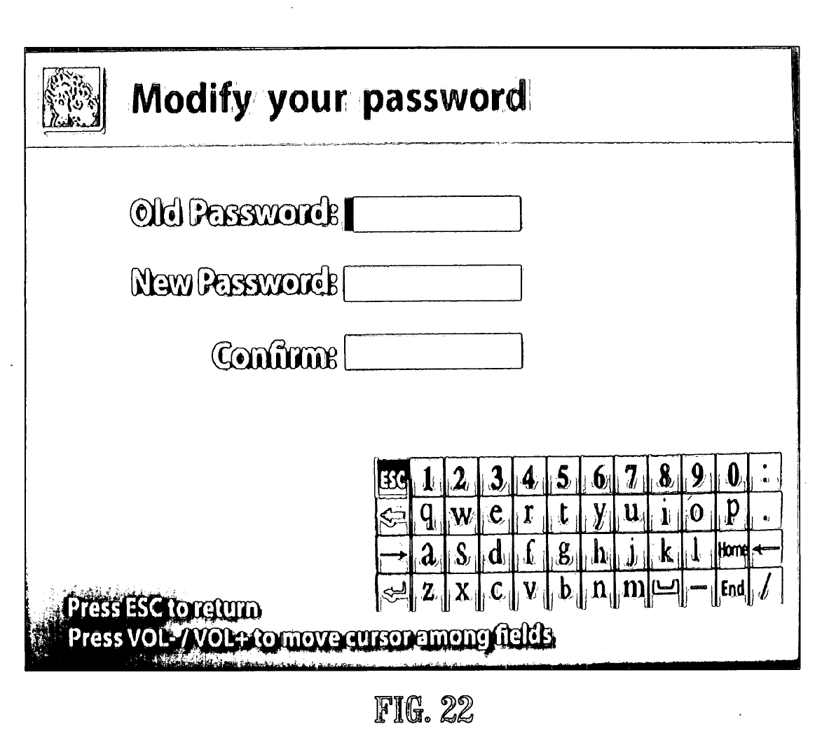

FIG. 19 shows the ‘system upgrade’ page displayed to alert the subscriber that a new version is being upgraded. It is noted that the software upgrade feature can be by imposition from the program manager server at the Content Delivery Center. In such instance, the page as shown in FIG. 19 is presented, preferably in between feature selections by the subscriber. FIG. 20 shows the requirement on the part of the subscriber to enter his user name and password when the STB is configured. Here, a virtual keyboard is made available onscreen for the subscriber to fill in the requested subscriber information. FIG. 21 is a webpage presented to the subscriber if the subscriber fails to connect to the Program Manager server with the configuration information. FIG. 22 shows a page for the subscriber to enter or modify his password information. The entered password information is forwarded by the Program Manager server to the Database for storage in the area associated with that user.

Having thus described exemplary embodiments of the present invention, it is to be understood that the invention defined by the appended claims is not to be limited by particular details set forth in the above description as many apparent variations thereof are possible without departing from the spirit or scope thereof as hereinafter claimed.

1. An on-demand video delivery system, comprising:
a program center having a content server for receiving and storing media signals representing humanly perceptible video programs and for converting the media signals into coded media data suitable for streaming over the Internet; and
a plurality of delivery servers, each connected to the content server and the Internet for establishing an unicast link over the Internet with a respective one of a plurality of set top boxes (STBs) to deliver, upon request made from an STB for a video program, the requested video program by streaming over the Internet using Internet Protocol (IP),
wherein each of the STBs includes: a buffer for receiving and temporarily storing a requested video program streamed from a delivery server over the Internet; a decoder for converting the coded media data to humanly perceptible video, and a processor for coordinating presentation of the humanly perceptible video to play on a television while the buffer receives packets of downstream coded media data from the respective delivery server.

2. The system of claim 1, wherein the coded media data is in a compressed form.

3. The system of claim 2, wherein the coded media data is MPEG4 compliant.

4. The system of claim 1, wherein the packets of coded media data is in H.264 Streaming Format.

5. The system of claim 1, wherein each of the delivery servers includes a streaming controller employing one of a RTSP, Real System, or MPEG4 streaming protocol to stream the coded media data to a STB.

6. The system of claim 1, wherein the presentation of the humanly perceptible video to play on a television is in one of interlaced, NTSC, or PAL format.

7. The system of claim 1, further including a program manager server configured to present on the Internet browsable pages including a subscriber welcome home page to the plurality of STBs.

8. The system of claim 7, wherein each of the STBs is configured to connect to the Internet with a browser and each STB has its browser preset to the subscriber welcome home page.

9. The system of claim 7, wherein the Internet browsable pages include a page with video program titles selectable by subscribers at the STBs.

10. The system of claim 9, wherein the video program titles selectable by subscribers include broadcast television programs and movie titles.

11. The system of claim 10, wherein the broadcast television programs selectable by subscribers are presented as a playlist and the playlist is updated contemporaneously when broadcast programs are changed by the broadcaster.

12. The system of claim 7, wherein the browsable pages include a bookmark page selectable by a subscriber to return to programs previously selected and partially viewed by the subscriber.

13. The system of claim 1, wherein each of the STBs is configured to receive and process video program viewing control commands including play, stop, pause, and forward and backward.

14. The system of claim 13, wherein upon receipt of a STOP command at an STB, information about the title and frame of the stopped video program is stored in a database at the program delivery center, and the information is retrieved upon the next selection of the same video program from the same STB to play back the video program from the point of stoppage.

15. The system of claim 1, wherein each of the STBs includes a network interface for connecting to a wireless access point (WAP).

16. The system of claim 1, wherein each of the STBs is identified by its MAC address.

17. The system of claim 1, wherein the content server includes an encoder for encoding television signals into H.264AVI signals and converting the H.264AVI signals to HSF signals suitable for transport via IP streaming; and
the decoder in each of the STBs decodes the H.264AVI signals and converts the decoded signals to media signals suitable for display on a television.

18. The system of claim 1, wherein the content server is configured to monitor the rate of receipt of streaming packets at a respective STB, and adjusts the size of the packets to be streamed based on the rate.

19. The system of claim 1, wherein at least one of the STBs further includes a DVR for storing video programs received from the program delivery center.

20. The system of claim 1, further including a database server having a database for storing subscriber information of each subscriber corresponding to each STB, including subscriber ID, password, preferences.

21. The system of claim 20, wherein the subscriber information further includes subscription package selected by the subscriber, and the subscription package is one of a basic fee plus fee per selection, or a no-limit-viewing package at a higher basic fee.

22. A set top box device, comprising:
a network interface for connecting to the Internet via an access point;
a web browser for accessing webpages via at least one preset URL;
a buffer for buffering streamed packets of coded media data representing portions of a video program;
a processor and software modules for decoding the coded media data, and
converting the decoded media data to humanly perceptible audio and video; and
a driver for formatting the humanly perceptible video in a format playable on a television, wherein the processor is configured to cause the video program to be played over the television and at the same time downstream portions of the video program are being received at the buffer.

23. The device according to claim 22, wherein the streamed packets are received using one of RTSP, Real System, MPEG4 protocols.

24. The device according to claim 22, wherein the access point is a wireless access point to facilitate wireless access to a remote program center via the Internet at the STB.

25. The device according to claim 22, wherein the coded media data is MPEG4 compliant.

26. The device according to claim 22, wherein the format playable on a television is one of interlaced, NTSC, or PAL.

27. The device according to claim 22, wherein the packets of streamed data are configured as serialized objects with byte sequences identified by markers.

28. The device according to claim 22, wherein the software modules include a plugin to receive remote control commands including play, stop, pause, and forward and backward, and the processor is configured to cause the video program to function according to the received commands.

29. The device according to claim 22, further including a plugin that presents a virtual keyboard on the television.

30. The device according to claim 22, wherein the processor is configured to acknowledge receipt of the packetized media data at a rate proportional to the rate of receipt of the packetized media data.

31. A method of on-demand video delivery, comprising:
storing media signals representing humanly perceptible video programs at a program center;
converting the media signals into coded media data suitable for streaming over the Internet;
establishing at a delivery server an unicast link over the Internet with a set top box (STB) requesting a video program, and streaming the requested video program over the Internet using Internet Protocol (IP); and
receiving the requested video program streamed over the Internet at the requesting STB, converting the coded media data to humanly perceptible video, and presenting the humanly perceptible video to play on a television while maintaining communications with the delivery server over the unicast link including receiving packets of downstream coded media data from the respective delivery server.
